(19) United States
(12) Patent Application Publication
(10) Pub. No.: US 2025/0200341 A1
(43) Pub. Date: Jun. 19, 2025

(54) RECURSIVE MEMORY USAGE TO INFER CONTEXT FOR GENERATIVE LARGE LANGUAGE MODEL INFERENCE

(71) Applicant: INTERNATIONAL BUSINESS MACHINES CORPORATION, ARMONK, NY (US)

(72) Inventors: SUBHAJIT CHAUDHURY, White Plains, NY (US); Payel Das, YORKTOWN HEIGHTS, NY (US); Soham Dan, Astoria Queens, NY (US); Georgios Kollias, White Plains, NY (US); Igor Melnyk, White Plains, NY (US)

(21) Appl. No.: 18/976,469

(22) Filed: Dec. 11, 2024

Related U.S. Application Data
(63) Continuation-in-part of application No. 18/537,993, filed on Dec. 13, 2023.

(51) Int. Cl. G06N 3/0475; G06F 17/15

(52) U.S. Cl. CPC G06N 3/0475; G06F 17/153

(57) ABSTRACT

A method, computer program product, and computer system. A generative large language model (LLM) receives a query of text and associated text data that includes N units of text for determining a context for the query. An embedding (Z_{query}) of the query and a vector Z including N embeddings is generated. The N elements of Z are distributed into C memory portions of the external memory unit. Each memory portion includes S memory locations, where C=CEILING (N/S). A process (a) ascertains a closest element in each memory portion that is closest to Z_{query}, and (b) distributes the ascertained closest elements into memory locations within a proper subset of the C memory portions, where (a) and (b) are recursively repeated until only a single closest element is ascertained from which a context is determined. A response to the query is generated based on the query and the context.

### CROSS REFERENCE TO RELATED APPLICATIONS

This application is a continuation in part application claiming priority to Ser. No. 18/537,993 filed Dec. 13, 2023, the contents of which are hereby incorporated by reference in its entirety.

### BACKGROUND

The present invention relates to generative artificial intelligence, and more particularly to enhancing a generative large language model by using an external memory unit.

### SUMMARY

Embodiments of the present invention provide a method, a computer program product, and a computer system.

An encoder in a generative large language model (LLM) receives a query of text and associated text data comprising N units of text for determining a context for the query, wherein N is at least 3. The encoder, a decoder in the generative LLM, and a memory network set in an external memory unit that is external to the encoder and the decoder have been jointly trained to provide responses to queries.

An embedding (Z_{query}) of the query and a vector Z comprising N elements are generated. Each element is an embedding of a different unit of text of the N units of text.

The N elements of Z are distributed into C memory portions of the external memory unit, wherein each memory portion consists of S memory locations, wherein C=CEILING (N/S), and wherein C is at least 2.

A process: (a) ascertains a closest element in each memory portion that is closest to Z_{query}, (b) distributes the ascertained closest elements into memory locations within a proper subset of the C memory portions, and recursively repeats (a) and (b) until only a single closest element is ascertained.

The decoder determines, from the single closest element, the context.

The decoder generates a response to the query, based on the query and the context.

### BRIEF DESCRIPTION OF THE DRAWINGS

FIG. 1 is a block diagram of a system for enhancing a generative LLM with an external memory unit, in accordance with embodiments of the present invention.

FIG. 2 is a block diagram of modules included in code included in the system of FIG. 1, in accordance with embodiments of the present invention.

FIG. 3 is a flowchart of a process of enhancing a generative LLM with an external memory unit, where operations of the flowchart are performed by the modules in FIG. 2, in accordance with embodiments of the present invention.

FIG. 4 is a block diagram of an overview of an architecture for enhancing a generative LLM with an external memory unit, in accordance with embodiments of the present invention.

FIG. 5 is a table presenting sample measurements of language model quality in relation to memory size, in accordance with embodiments of the present invention.

FIG. 6 is a table presenting sample measurements of language model quality in relation to model size, in accordance with embodiments of the present invention.

FIG. 7 depicts flowcharts of a write operation and a read operation provided by the framework in the process of FIG. 3, in accordance with embodiments of the present invention.

FIG. 8 depicts flowcharts of a write operation and a generate operation provided by the framework in the process of FIG. 3, in accordance with embodiments of the present invention.

FIG. 9 depicts details of write and read operations provided by the framework in the process of FIG. 3, in accordance with embodiments of the present invention.

FIG. 10 is an example of read, write, and generate operations provided by the framework in the process of FIG. 3, in accordance with embodiments of the present invention.

FIG. 11 is a block diagram of model training on unlabeled sentences, as included in the process of FIG. 3, in accordance with embodiments of the present invention.

FIG. 12 is a block diagram of model training on labeled sentences, as included in the process of FIG. 3, in accordance with embodiments of the present invention.

FIG. 13 is a block diagram of a model training on labeled sentences using a positive label memory and a negative label memory, in accordance with embodiments of the present invention.

FIG. 14 is an example of knowledge updating in the process of FIG. 3, in accordance with embodiments of the present invention.

FIG. 15 illustrates an example of determining a context for a query submitted to a generative LLM, in accordance with embodiments of the present invention.

FIG. 16 is a flow chart of a method for generating a response to the query by a generative LLM using memory portions in an external memory unit recursively to determine the context for the query, in accordance with embodiments of the present invention.

FIG. 17 is a flow chart of a process that ascertains the closest element in the memory portion P that is closest to an embedding of the query, in accordance with embodiments of the present invention.

FIG. 18 depicts a table presenting FastFacts recall rate performance for baseline artificial intelligence (AI) models and the inventive regenerative LLM models of the present invention, in accordance with embodiments of the present invention.

FIG. 19 is a flow chart of a process for determining the number of embeddings to be stored in a memory portion of the external memory unit, in accordance with embodiments of the present invention.

### DETAILED DESCRIPTION

### Overview

A generative large language model (LLM) (e.g., a generative artificial intelligence (AI) chatbot or a computer vision tool) can generate hallucinations by perceiving patterns or objects that are nonexistent or imperceptible to human observers, which lead to outputs that are factually incorrect or nonsensical, or include invented details. LLM-generated hallucinations may facilitate the spread of misinformation and can reinforce biases and stereotypes present in training data, thereby worsening social problems such as discrimination. These hallucinations can also weaken trust in AI content and obstruct the adoption of AI in certain domains.

Embodiments of the present invention address the aforementioned unique challenges by providing a generative LLM (i.e., an LLM encoder-decoder) that is augmented with one or more external memory units that include a generative associative memory network set (also referred to herein as an episodic associative memory network). Hereinafter, the generative LLM augmented with the aforementioned external memory unit is also collectively referred to as the enhanced generative LLM.

The enhanced generative LLM mimics the bi-directional neocortex-hippocampus interactions and divisions of labor in the human brain, thereby providing the generative LLM with an ability to explicitly encode information and form memories, which facilitates the performing of tasks that require long-term dependencies, such as hallucination prevention, reasoning, generalization, and value alignment. The neocortex, which interacts with the world and maintains a semantic representation of the world, is approximated by the generative LLM. The hippocampus, which retains recent (i.e., episodic) memories, gradually consolidates the recent memories into longer-term memories, and is involved in the retrieval of memories is approximated by the generative associative memory network set.

In one embodiment, the generative LLM is significantly larger in size and complexity than the external memory unit. The external memory unit is associative, generative, and sparsely distributed. Because of the sparsely distributed aspect and latent encoding of memory, the memory size in the enhanced generative LLM architecture is independent of the input data dimensions. Furthermore, the sparsely distributed aspect allows an increase in the capacity of associative memory by reducing overlap between memory representations.

In one embodiment, the framework provided by the enhanced generative LLM memory provides (i) associativity (i.e., memory retrieval with denoising), (ii) generative memory (i.e., sampling from learned memory distribution), (iii) fast and dynamic update (i.e., memory that is explicitly modified at runtime), (iv) memory-based inference (i.e., at generation time (also known as decoding time), the distribution is conditioned on memory), and (v) scalability (i.e., efficient memory storage whereby the number of storage items can grow per fixed memory size without significant information loss). The aforementioned associativity includes an ability to retrieve a remembered pattern based on a distorted or incomplete version of the pattern. The aforementioned fast and dynamic update includes a fast belief update in response to an arrival of a new data episode, thereby enabling fast episodic learning.

In one embodiment, the enhanced generative LLM provides novel generation, which enables improved generation from the memory of a learned episode, as well as generative replay. In one embodiment, the enhanced generative LLM provides off-line replay, which enables memory consolidation.

The enhanced generative LLM provides memory replay that supports fact checking and continual learning. Furthermore, the enhanced generative LLM provides sample quality improvement via denoising and generating, thereby resulting in sample-efficient model alignment and hallucination prevention.

In one embodiment, training methods are provided to jointly optimize the LLM decoder and the external memory unit, resulting in a model that learns to store sentence encodings in a memory matrix, which is used during decoding.

In one embodiment, the trained enhanced generative LLM can quickly learn and quickly update the external memory unit during inference (like the brain's hippocampus), thereby promoting an adaptivity of the enhanced generative LLM, which provides an integrated learning system like the human brain, and which further provides an advantage over the slow learning aspect of conventional implementations of a generative LLM.

In one embodiment, the enhanced generative LLM provides accurate, fast, and dynamic operations that read from, write into, denoise from, and generate from memory.

In one embodiment, the enhanced generative LLM improves language modeling by reducing reconstruction error and language perplexity, provides one-shot learning and generation during inference, even with out of distribution data, provides a fast and accurate knowledge update of the decoder during inference, and provides a fast and near perfect memory recall.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

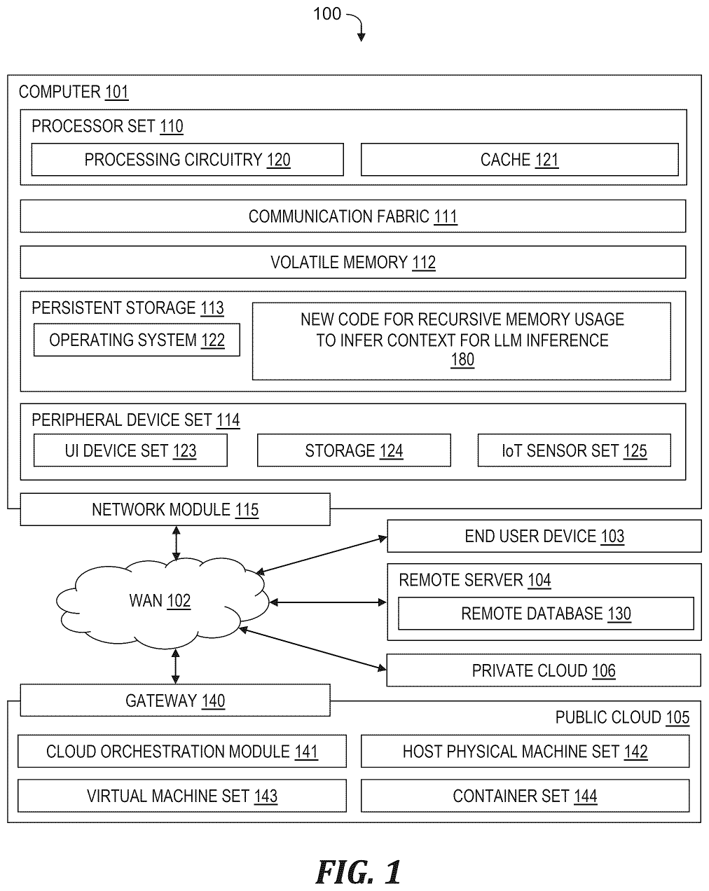

FIG. 1 depicts a computing environment 100 which contains an example of an environment for the execution of at least some of the computer code involved in performing the inventive methods, in accordance with embodiments of the present invention. Such computer code includes new code for recursive memory usage to infer context for large language model (LLM) inference 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

System and Process for Enhancing a Generative LLM with an External Memory Unit

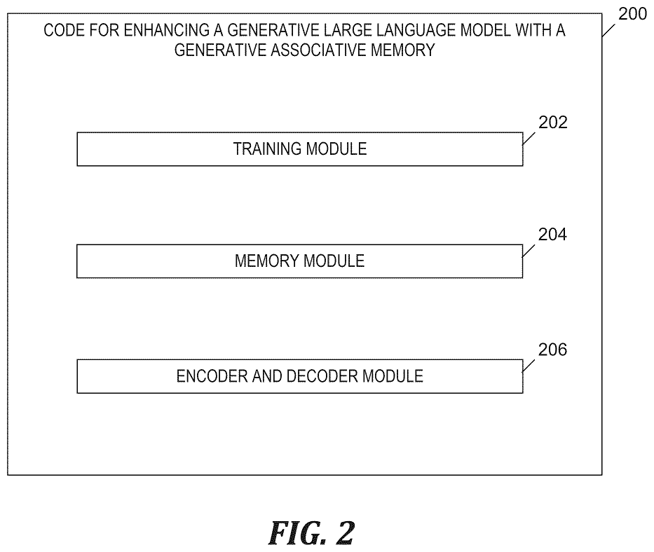

FIG. 2 is a block diagram of modules included in code 200 included in the system 100 of FIG. 1, in accordance with embodiments of the present invention. Code 200 includes a training module 202, a memory module 204, and an encoder and decoder module 206.

Training module 202 is configured to jointly train, end-to-end, (i) an encoder and a decoder included in a generative LLM and (ii) an external memory unit, which results in a joint optimization of the decoder and the external memory unit. As a result of the joint training, the generative LLM and external memory unit learn to store sentence encodings in a memory matrix, which is used during decoding performed by the decoder. The joint training ensures that the generative associative memory network set included in the external memory unit is sparsely distributed. That is, the capacity of the generative associative memory network set can be increased by reducing overlap between memory representations.

Memory module 204 is configured to augment the generative LLM with a global memory in the external memory unit, so that in response to an update to the global memory, the generative LLM can perform operations efficiently in accordance with the updated global memory, which can assist in updating knowledge and preventing hallucinations. The external memory unit is associative, generative, and sparsely distributed, stores episodic memories (i.e., information about a recent episode or a past episode), and consolidates stored episodic memories into a long-term memory. Memory module 204 is further configured to perform a fast update of the generative associative memory network set during an inference, thereby mimicking the hippocampus of the human brain and providing the generative LLM with a novel adaptivity to updated information, without requiring the traditional re-training or fine-tuning of the generative LLM.

Memory module 204 is further configured to provide fast and accurate memory operations, including a write into, a read from, a denoise from, and a generate from the generative associative memory. In one embodiment, memory module 204 provides other memory operations, such as free-form and prompt-based generation from a memory episode, memory retrieval with a partial or noisy prompt, memory update as a new data episode arrives, iterative denoising, and iterative memory update.

Memory module 204 is further configured to provide an improved language modeling which is indicated by an improvement in sentence reconstruction error and an improvement in language perplexity. Memory module 204 is further configured to provide one-shot learning and generation during an inference, even if the data is out of distribution (OOD) to what the model has been shown previously.

Memory module 204 is further configured to provide fast and accurate knowledge update of the decoder during an inference, fast and near perfect memory recall, and memory consolidation (i.e., consolidating recent (i.e., episodic) memories into long-term memories).

Encoder and decoder module 206 is configured to use a neural network as an encoder to generate a low-dimensional representation of a language input as a latent vector. Encoder and decoder module 206 is further configured to use a decoder to decode a memory encoding of the language input. Encoder and decoder module 206 is further configured to perform fast and accurate knowledge update of the decoder during an inference, without fine-tuning or re-training the generative LLM. Encoder and decoder module 206 is further configured to generate a response to a prompt during an inference. In one embodiment, the response generated by the encoder and decoder module 206 is based on the aforementioned knowledge update of the decoder.

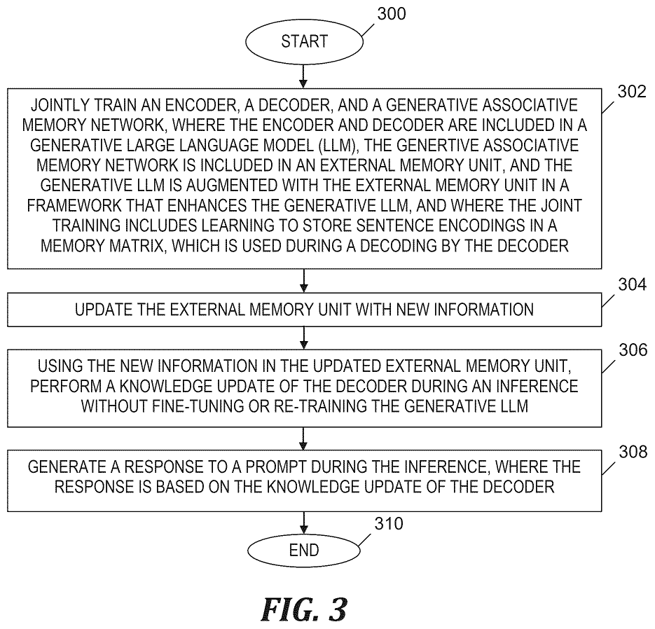

The functionality of the modules included in code 200 is described in more detail in the discussions presented below relative to FIG. 3 through FIG. 13, inclusive.

FIG. 3 is a flowchart of a process of enhancing a generative LLM with an external memory unit, where operations of the flowchart are performed by the modules in FIG. 2, in accordance with embodiments of the present invention. The process of FIG. 3 begins at a start node 300. In step 302, training module 202 jointly trains an encoder, a decoder, and a generative associative memory network set. The encoder and decoder are included in a generative LLM. The generative associative memory network set is included in an external memory unit. The generative LLM is augmented with the external memory unit in a framework that enhances the generative LLM. The joint training performed in step 302 includes learning the store sentence encodings or language encodings in a memory matrix, which is used during a decoding performed by the decoder.

In step 304, memory module 204 updates the external memory unit with new information.

In step 306, using the new information in the updated external memory unit, encoder and decoder module 206 performs a knowledge update of the decoder during an inference, without fine-tuning or re-training the generative LLM.

In step 308, encoder and decoder module 206 generates a response to a prompt during the inference. The response is based on the knowledge update of the decoder, which was performed in step 306.

Following step 308, the process of FIG. 3 ends at an end node 310.

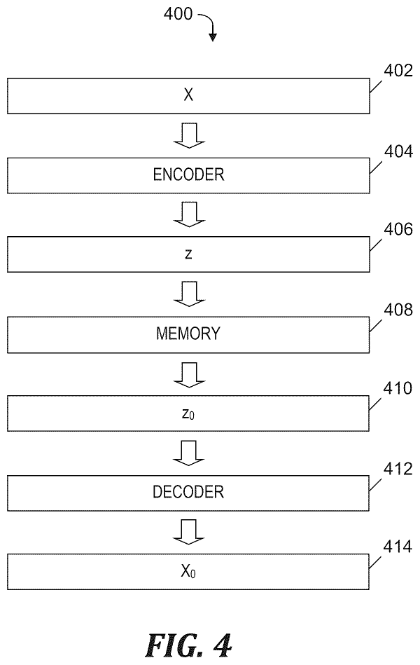

FIG. 4 is a block diagram of an overview 400 of an architecture for enhancing a generative LLM with an external memory unit, in accordance with embodiments of the present invention. Overview 400 includes a data input 402 (i.e., X), which is input into an encoder 404. Encoder 404 is a neural network included in the generative LLM. Encoder 404 outputs a latent vector 406 (i.e., z), which is the low-dimensional representation of X. The latent vector z is input into a memory 408, which is the generative associative memory included in the external memory unit that augments the generative LLM. Memory 408 is a fixed-size memory. Memory 408 outputs a latent vector 410 (i.e., z₀), which is the memory encoding of X. The latent vector z₀ is input into a decoder 412, which is another neural network included in the generative LLM. Decoder 412 outputs a data output 414 (i.e., X₀). Again, training module 202 jointly trains and optimizes encoder 404, memory 408, and decoder 412. In another embodiment, memory 408 is replaced with a generative associative memory network set.

Memory 408 is a stand-alone module, which means that it is not added to, and remains separate from, encoder 404 and decoder 412. Memory 408 is generative (i.e., not deterministic), which means that memory writes and reads are inferences in a generative model, where memory 408 is treated as a distribution (i.e., p(M)). The framework that includes encoder 404, memory 408, and decoder 412 decouples the size of memory 408 from the input data size (i.e., the size of memory 408 is independent of the input data size, which provides improved scalability). Memory 408 adds only K×C+1 extra parameters to the original encoder-decoder model (i.e., a conventional generative LLM), where K is the number of slots desired for memory 408 and C is the latent dimension (i.e., the dimension of the aforementioned latent vector z).

One property of memory 408 is associativity, which means that any language input can be denoised. By having associativity, memory 408 can retrieve a remembered pattern based on a distorted or incomplete version.

Memory 408 is sparsely distributed, which means memory 408 can increase its capacity by reducing overlap between memory representations.

Memory 408 has another property of dynamic inference (i.e., memory update), which provides a fast update during an inference (e.g., a fast belief update in response to an arrival of a new data episode), thereby enabling fast episodic learning. The dynamic inference property of memory 4087 also allows a building of a new episode, and generating and learning from the new episode during an inference, with no request for a re-training of the generative LLM.

Another property of memory 408 is novel generation. That is, memory 408 enables an improved generation from memory 408 of a learned episode, as well as a generative replay.

Memory 408 also provides off-line replay, which enables memory consolidation.

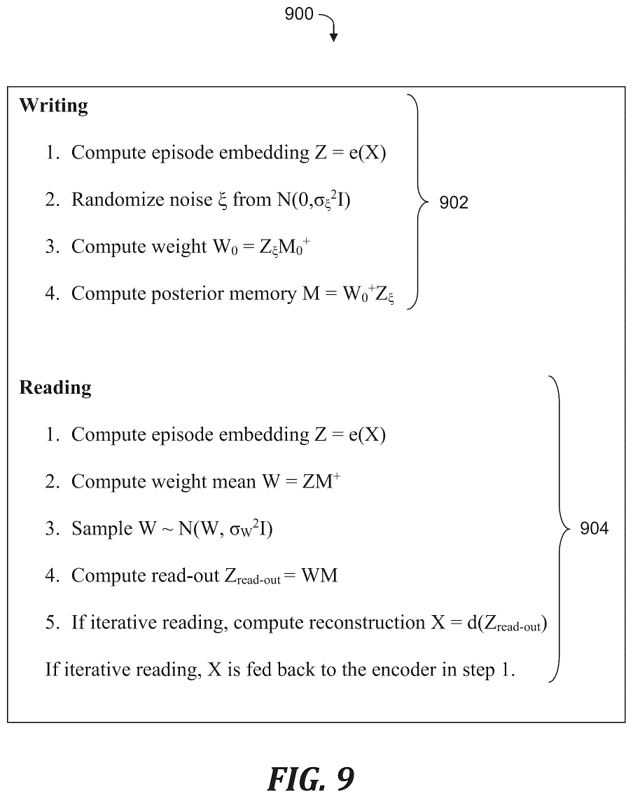

Memory 408 also provides memory learning details whose writing and reading details are discussed below relative to FIG. 9. Other details related to memory learning details include training loss (i.e., the loss being used to train an instantiation of the framework that includes the enhanced generative LLM disclosed herein), which is defined as:

$$- {E}_{q ( W )} ln p ( X \vert W , M ) + {D}_{KL} ( q ( W ) ‖ p ( W ) ) - {E}_{X ∼ data} ln p ( d ( e ( X ) ) ) ,$$

where −E_{q}(w) ln p (X|W,M) is sentence reconstruction loss, D_{KL}(q(W)∥p(W)) is Kullback-Leibler (KL) divergence loss, and E_{X-data} ln p(d(e(X))) is autoencoder (AE) loss.

Training for the framework may also include one or more of the following add-ons:
(i) a regularization on Z+ (Zᵣ−Z_{q})²
(ii) a regularization on pretraining data
(iii) a regularization on memory matrix structure
(iv) a different regularizer between prior and posterior distributions of W, such as Wasserstein distance
(v) a different, more complex initial prior than identity matrix or random matrix, like a mixture of gaussians
(vi) updating of only a small subset of parameters in encoder and/or decoder

Other details related to memory learning details include an inference, during which the following optimization problem is solved:

$$\begin{matrix}min \\ M\end{matrix} {‖ {W}_{0} M - {Z}_{ξ} ‖}_{F}^{2} ,$$

where W₀ is the projection or keys of a specific sentence, M is the memory, and Z_{ξ} is the noisy version of the encoding. Inference may additionally include:
(i) a regularization on M, such as

$$\begin{matrix}min \\ M\end{matrix} {‖ {W}_{0} M - {M}_{0} ‖}_{F}^{2}$$

(ii) a regularization on W sparsity ∥W̅∥_{F}²

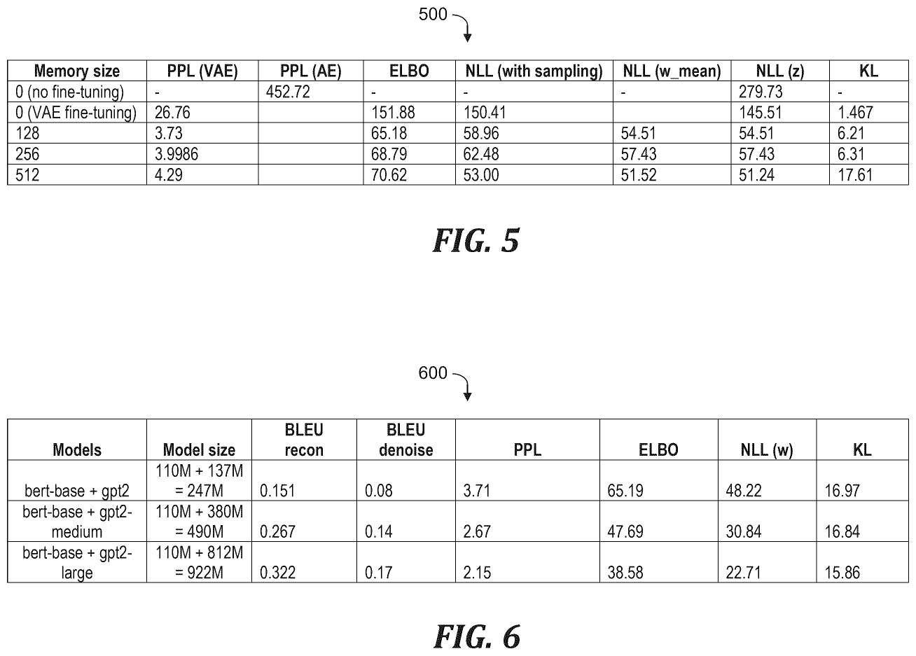

FIG. 5 is a table 500 presenting sample measurements of language model quality in relation to memory size, in accordance with embodiments of the present invention. Descriptions for acronyms in the column headers in table 500 are presented below:
PPL: perplexity
VAE: variational autoencoder
AE: autoencoder
ELBO: evidence lower bound
NLL: negative log likelihood
KL: Kullback-Leibler divergence score

Table 500 includes sample measurements that indicate that the training of the generative LLM with the generative associative memory network set leads to improved language model quality. For example, the negative log likelihood decreases as memory changes from no memory to a non-zero memory size, as indicated by comparing the 279.73 measurement under NLL (z) for the first row (i.e., 0 memory size) versus the lower NLL (z) measurements 54.51, 57.43, and 51.24 in the rows having memory sizes 128, 256, and 512, respectively. The decrease in the NLL indicates that the addition of the memory improves the language model quality. As another example, the perplexity measurement decreases as memory changes from no memory to a non-zero memory size (e.g., compare the 26.76 PPL value in table 500 corresponding to a 0 memory size to the lower PPL values of 3.73, 3.9986, and 4.29 corresponding to memory sizes of 128, 256, and 512, respectively). The decrease in PPL indicates that the addition of memory improves the language model quality.

FIG. 6 is a table 600 presenting measurements of language model quality in relation to model size, in accordance with embodiments of the present invention. Descriptions for the column headers in table 600 are presented below:
BLEU: bilingual evaluation understudy
PPL: perplexity
ELBO: evidence lower bound
NLL: negative log likelihood
KL: Kullback-Leibler divergence score

Table 600 includes sample measurements that indicate that improved language model quality correlates with increasing model size. For example, the perplexity measurements decrease (i.e., 3.71 to 2.67 to 2.15) as the model size increases (i.e., 247M to 490M to 922M). The decrease in PPL indicates that the increase in model size improves the language model quality.

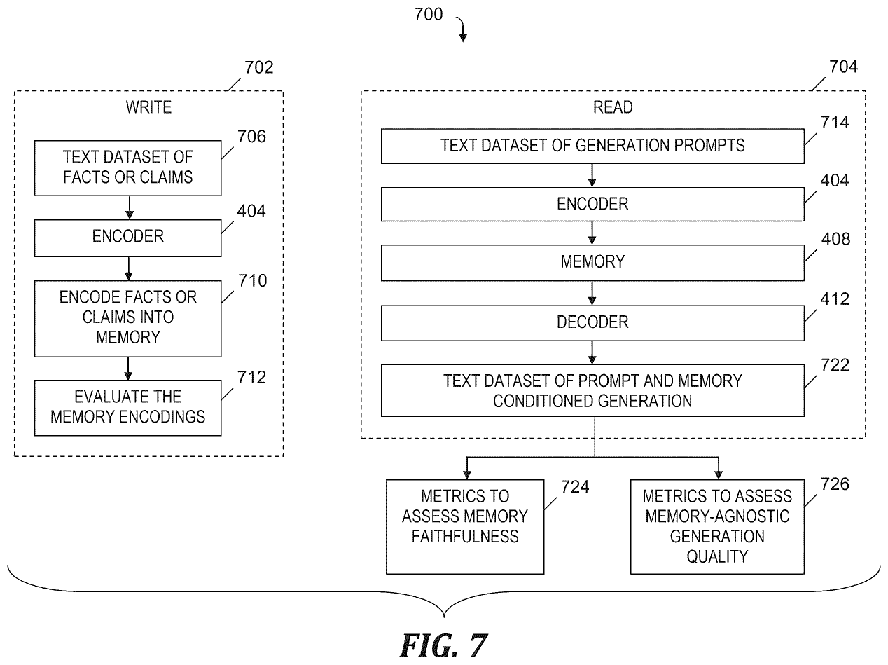

FIG. 7 depicts flowcharts 700 of a write operation 702 and a read operation 704 provided by the framework in the process of FIG. 3, in accordance with embodiments of the present invention. The flowcharts 700 include the write operation 702, which starts with a text dataset of facts or claims 706 being input into encoder 404. In step 710, encoder 404 encodes the facts or claims. Using the encoded facts or claims and a prior memory M₀, encoder 404 computes a writing weight W₀, which is then used to write the encoded facts or claims into memory 408 (i.e., a posterior memory M) as memory encodings. In step 712, encoder 404 evaluates the memory encodings (e.g., separation in latent space between facts with opposing polarity).

The flowcharts 700 include the read operation 704, which starts with a text dataset of generation prompts 714 being input into encoder 404, which encodes the prompts. Encoder 404 uses the encoded prompts and memory 408 to compute a reading weight W for memory conditioned reading. The matrix product of W and M calculates the memory read-out. Decoder 412 uses the memory read-out to generate the text dataset of prompt and memory conditioned generation 722 as output. An evaluation of the output includes (i) metrics to assess memory faithfulness 724 (e.g., factuality, robustness, fact edits, forgetting, etc.) and (ii) metrics to assess memory-agnostic generation quality 726 (e.g., fluency, consistency, perplexity, etc.).

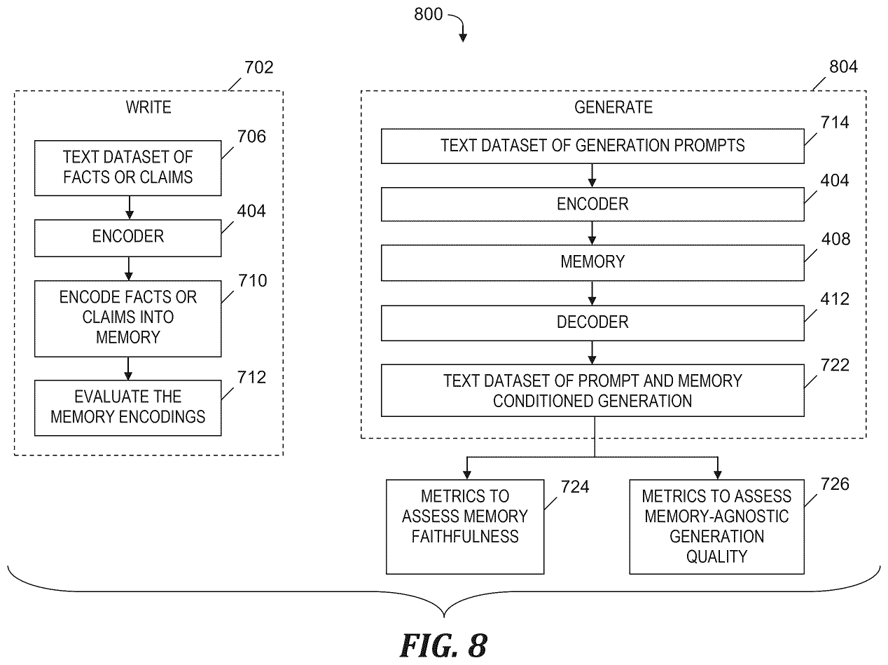

FIG. 8 depicts flowcharts 800 of a write operation 702 and a generate operation 804 provided by the framework in the process of FIG. 3, in accordance with embodiments of the present invention. The flowcharts 800 include the write operation 702, which is described above relative to FIG. 7.

The flowcharts 700 includes the generate operation 804, which starts with a text dataset of generation prompts 714 being input into encoder 404, which encodes the prompts. Encoder 404 uses the encoded prompts and memory 408 to compute a generating weight W for memory conditioned generation. Decoder 412 uses W and memory 408 to generate the text dataset of prompt and memory conditioned generation 722 as output. An evaluation of the output includes (i) metrics to assess memory faithfulness 724 (e.g., factuality, robustness, fact edits, forgetting, etc.) and (ii) metrics to assess memory-agnostic generation quality 726 (e.g., fluency, consistency, perplexity, etc.).

FIG. 9 depicts details 900 of write and read operations provided by the framework in the process of FIG. 3, in accordance with embodiments of the present invention. Details 900 include details of a process 902 for writing provided by the framework. Process 902 includes four steps. In step 1 of process 902, the episode embedding Z=e(X) is computed. That is, encoder 404 encodes an episode X as Z. In step 2, encoder 404 randomizes noise ξ from N(0,σ_{ξ}²I). In step 3, encoder 404 computes an estimated weight W₀=Z_{ξ}M₀⁺, where W₀ is the writing weight and M₀ is the prior memory. In step 4, encoder 404 computes posterior memory M=W₀⁺Z_{ξ}.

Details 900 include details of a process 904 for reading provided by the aforementioned framework. Process 904 includes five steps. In step 1 of process 904, encoder 404 computes episode embedding Z=e(X) (e.g., the query X_{q} is encoded as Z_{q}). In step 2, encoder 404 computes the reading weight mean W=ZM⁺. In step 3, if generating (instead of reading) from memory is being performed, then encoder 404 uses a variational schema for generating samples, i.e., W˜N(W, σ_{W}²I). In step 4, encoder 404 computes the memory read-out Z_{read-out}=WM (i.e., the matrix product of W and M). Although not shown in FIG. 9, in a step following step 4, the decoder 412 uses Z_{read-out} to generate the output X₀ of the reading phase. In step 5, if iterative reading is included during an inference, encoder 404 computes reconstruction X=d(Z_{read-out}) and X is fed back to encoder 404 in step 1 of process 904 (i.e., for the next reading step).

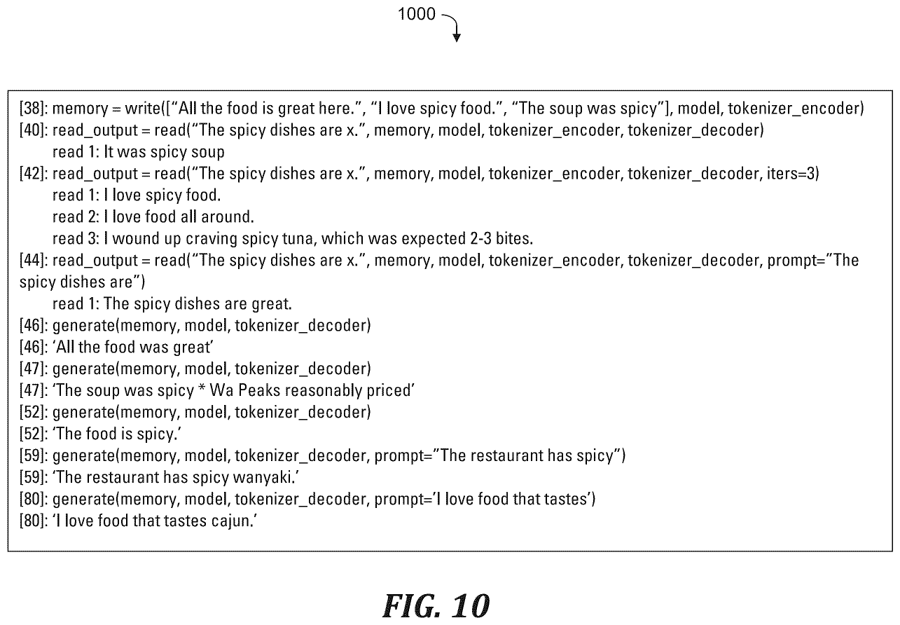

FIG. 10 is an example 1000 of read, write, and generate operations provided by the framework in the process of FIG. 3, in accordance with embodiments of the present invention.

In the line labeled “[38],” example 1000 includes a sample write into memory 408 happening in real time during an inference.

In lines labeled “[40],” “[42],” and “[44],” example 1000 includes samples of an operation that reads from memory 408, which asks the language model to read that the spicy dishes are x.

In lines labeled “[46],” “[47],” and “[52],” example 1000 includes samples of operations that generate from memory 408 without a prompt. For instance, in line [46], the language model generated “All the food was great.”

In lines labeled “[59]” and “[80],” example 1000 includes samples of operations that generate from memory 408 with a prompt. For example, with the prompt “The restaurant has spicy” in line [59], the language model generated “The restaurant has spicy wanyaki.”

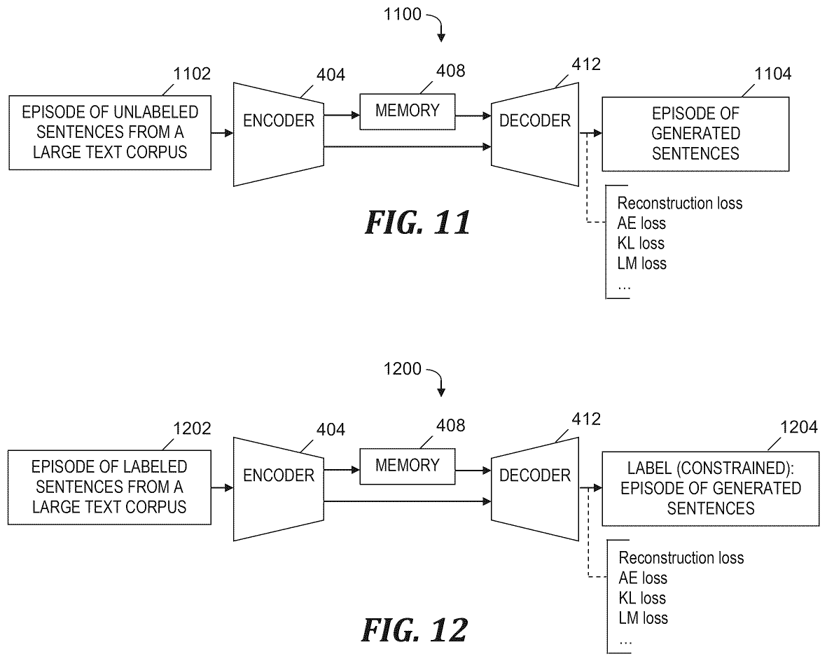

FIG. 11 is a block diagram of model training 1100 on unlabeled sentences, as included in the process of FIG. 3, in accordance with embodiments of the present invention. Model training 1100 can include writing, reading, and generating sentences from memory 408 and starts with an episode of unlabeled sentences from a large text corpus 1102, which is input into encoder 404. Encoder 404 outputs a low-dimensional representation of the episode of sentences 1102. In response, the low-dimensional representation is input into memory 408, which outputs a memory encoding of the episode of sentences 1102. The memory encoding is input into decoder 412. In response, decoder 412 generates an episode of generated sentences 1104 as data output. The model training 1100 is subject to training loss that can include reconstruction loss, AE loss, KL loss, language modeling (LM) loss, etc. Definitions of reconstruction loss, AE loss, and KL loss are found in the discussion of FIG. 4, presented above.

FIG. 12 is a block diagram of model training 1200 on labeled sentences, as included in the process of FIG. 3, in accordance with embodiments of the present invention. Model training 1200 can include writing, reading, and generating sentences from memory 408 using label guidance and starts with an episode of labeled sentences from a large text corpus 1202, which is input into encoder 404. Encoder 404 outputs a low-dimensional representation of the episode of labeled sentences 1202. In response, the low-dimensional representation is input into memory 408, which outputs a memory encoding of the episode of labeled sentences 1202. The memory encoding is input into decoder 412. In response, decoder 412 generates a label (constrained): episode of generated sentences 1204 as data output. The model training 1200 is subject to training loss that can include reconstruction loss, AE loss, KL loss, LM loss, etc. Definitions of reconstruction loss, AE loss, and KL loss are found in the discussion of FIG. 4, presented above.

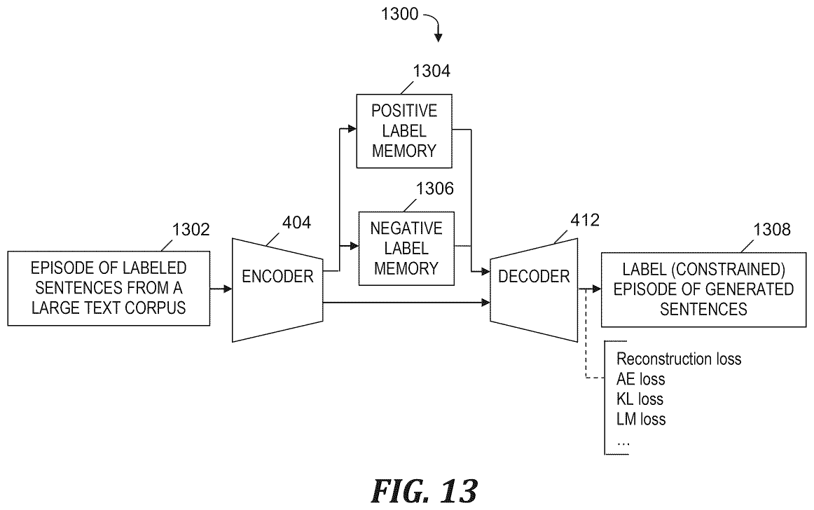

FIG. 13 is a block diagram of a model training 1300 on labeled sentences using a positive label memory and a negative label memory, in accordance with embodiments of the present invention. Model training 1300 illustrates how the enhanced generative LLM can influence the LLM decoder with different memories. Model training 1300 starts with an episode of labeled sentences from a large text corpus 1302, which is input into encoder 404. Encoder 404 outputs low-dimensional representations of the episode of labeled sentences 1302, thereby sending any representation (i.e., sample) having a positive class label to positive label memory 1304 and sending any representation having a negative class label to negative label memory 1306. In this case, each of the samples complies to one of the two classes (i.e., positive class or negative class). Thus, positive label memory 1304 has knowledge of the samples with positive class labels and negative label memory 1306 has knowledge of the samples with negative class labels. The classes can be representative of different topics, sentiments, or tenses. Positive label memory 1304 and negative label memory 1306 output memory encodings of the samples from episode of labeled sentences 1302. The memory encodings are input into decoder 412. In response, decoder 412 generates a label (constrained) episode of generated sentences 1308 as data output. The model training 1300 is subject to training loss that can include reconstruction loss, AE loss, KL loss, LM loss, etc. Definitions of reconstruction loss, AE loss, and KL loss are found in the discussion of FIG. 4, presented above.

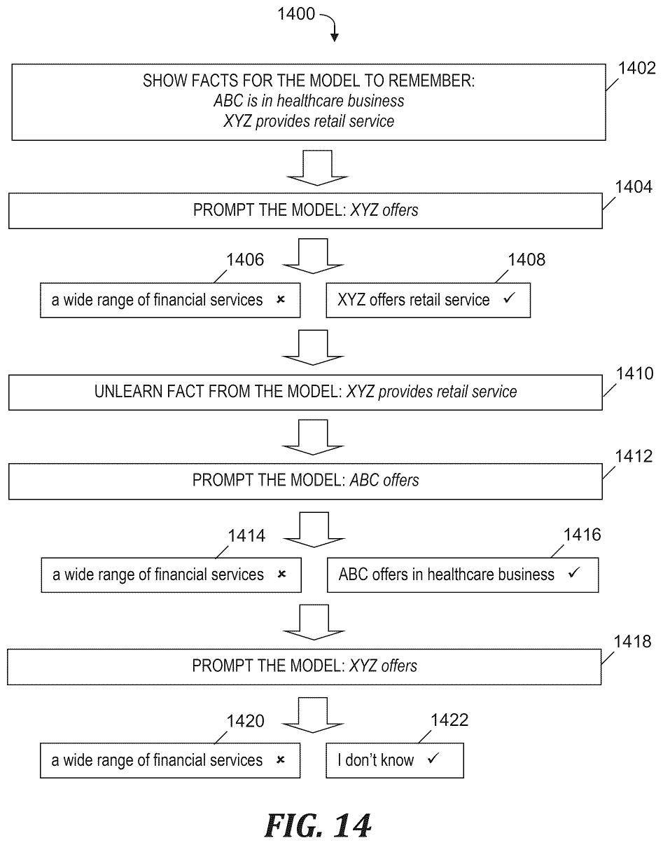

FIG. 14 is an example 1400 of knowledge updating in the process of FIG. 3, in accordance with embodiments of the present invention. Example 1400 illustrates that the enhanced generative LLM disclosed herein provides fast and efficient knowledge updating (also referred to as knowledge editing) as compared to a conventional language model (e.g., GPT-NeoX-20B). Knowledge editing techniques for a conventional language model rely on re-training of the model or finding out where to edit within the model (i.e., fine-tuning of the model). For the enhanced generative LLM disclosed herein, knowledge editing does not need re-training or finding out where to edit within the model because the knowledge edit is immediately reflected in an update to memory 408, which is a global memory.

When two boxes are shown in a single row in FIG. 14, the box on the left corresponds to a response provided by the conventional language model, and the box on the right corresponds to the enhanced generative LLM disclosed herein. An “x” indicator in a box indicates that the response in that box is false, while a checkmark indicator in a box indicates that the response in that box is true.

In step 1402, two facts are shown for each of the two models to remember: “ABC is in healthcare business” and “XYZ provides retail service.” In step 1404, each of the two models receives the prompt “XYZ offers.”

In response to the prompt, the conventional language model generates a response 1406 (i.e., “a wide range of financial services”), which is false, while the enhanced generative LLM generates a response 1408 (i.e., “XYZ offers retail service”), which is true. Being a large model, the conventional language model avoids frequent re-training and fine-tuning, so the facts shown in step 1402 are not yet part of a knowledge edit in the conventional language model. On the other hand, the global memory used by the enhanced generative LLM disclosed herein is quickly updated with the facts shown in step 1402, so response 1408 incorporates the knowledge edit without delay.

In step 1410, a fact of “XYZ provides retail service” is unlearned from each of the two models.

In step 1412, each of the two models is prompted with “ABC offers.” In response to the prompt, the conventional language model generates a response 1414 (i.e., “a wide range of financial services”), which is false, and the enhanced generative LLM generates a response 1416 (i.e., “ABC offers in healthcare business”), which is true. Again, the difference between response 1414 and 1416 reflects how the conventional language model has not yet completed a knowledge edit with the facts shown in step 1402, while the enhanced generative LLM can incorporate the knowledge edit in response 1416 because the global memory is quickly updated with the knowledge edit.

In step 1418, each of the models receives the prompt, “XYZ offers.” In response to the prompt in step 1418, the conventional language model generates a response 1420 (i.e., “a wide range of financial services”), which is false. In response to the prompt, the enhanced generative LLM disclosed herein generates a response 1422 (i.e., “I don't know”), which is true because the fact about the service provided by XYZ was unlearned in step 1410 and this unlearning edit is quickly available to the enhanced generative LLM via the global memory.

### Recursive Memory Usage to Infer Context for Regenerative Large Language Model Inference

According to an aspect of the invention, an encoder in a generative large language model (LLM) receives a query of text and associated text data comprising N units of text for determining a context for the query, wherein N is at least 3. The encoder, a decoder in the generative LLM, and a memory network set in an external memory unit that is external to the encoder and the decoder have been jointly trained to provide responses to queries. An embedding (Z_{query}) of the query and a vector Z comprising N elements are generated. Each element is an embedding of a different unit of text of the N units of text. The N elements of Z are distributed into C memory portions of the external memory unit, wherein each memory portion consists of S memory locations, wherein C=CEILING (N/S), and wherein C is at least 2. A process: (a) ascertains a closest element in each memory portion that is closest to Z_{query}, (b) distributes the ascertained closest elements into memory locations within a proper subset of the C memory portions, and recursively repeats (a) and (b) until only a single closest element is ascertained. The decoder determines, from the single closest element, the context. The decoder generates a response to the query, based on the query and the context.

The preceding aspect of the invention provides a technical feature of using memory recursively to determine the context, which utilizes a memory hierarchy similar to the memory hierarchy found in the hippocampus and improves an accuracy of the response to the query.

According to one embodiment, z denotes a vector that is a subset of the vector Z and is stored in a memory portion P of the C memory portions or in one of the proper subsets of the C memory portions, wherein said ascertaining the closest element z_{c} in the memory portion P that is closest to Z_{query} comprises: identifying an initial K×D matrix M₀, wherein D is a size of the embedding of each element of Z, K is an integer in a range governed by N≤K≤Eₘₐₓ, and Eₘₐₓ is a maximum number of embeddings that can fit into the external memory unit; generating a random number vector ξ having D elements by randomly sampling a multivariate normal distribution N(0, σ_{ξ}²I), wherein I is a unit matrix, and wherein σ_{ξ} is a specified constant; computing a K×D matrix M according to M=((z+ξ) M₀⁺)⁺ (z+ξ), wherein the vector z has D elements; and storing M in the external memory unit.

The preceding embodiment advantageously computes and stores a matrix M which includes a random component added to the embeddings of the units of text.

According to one embodiment, Z_{query} is structured as a vector of dimension D, wherein said ascertaining the closest element z_{c} in the memory portion P that is closest to Z_{query} further comprises: computing W according to W=Z_{query} M⁺; generating a random number vector W′ of dimension K by randomly sampling a multivariate normal distribution N(W, σ_{W}²I), wherein ow was learned during the training of the memory network set in the external memory unit; computing a vector Z_{read-out} of dimension D according to Z_{read-out}=W′M, wherein Z_{read-out} has a magnitude indicative of a distance between the respective element of z and Z_{query}; and ascertaining z_{c} from Z_{read-out} by determining which element of Z_{read-out} has a smallest magnitude.

The preceding embodiment advantageously provides an efficient method of ascertaining a closest embedding element in the memory portion that is closest to the embedding of the query.

According to one embodiment, the memory network set in the external memory unit was trained with memory portions consisting of T memory locations or an average of T memory locations, wherein 2 #T #S, and wherein S=T in one embodiment.

The preceding embodiment advantageously uses a memory portion size that is similar to the size of the input training window.

According to one embodiment, each execution of (a) and (b) is a recursive iteration, wherein n recursive iterations are performed to ascertain the single closest element, wherein nₘₐₓ is a specified maximum value of n, and wherein the method comprises: computing S′ according to S′=CEILING (exp(ln N/nₘₐₓ)); determining that S′>T; and setting S=S′.

The preceding embodiment advantageously provides a trade-off between how close S is to the original training size T to improve performance and how many embeddings can be fitted in each memory portion to reduce depth of recursion.

During inference, a trained generative LLM may receive a query of text and text data comprising N units of text (e.g., N paragraphs, N sentences, N phrases, N words, etc.) for determining a context for the query. The generative LLM generates a response to the query based on the query and the context.

The generative LLM was trained using T units of text for determining context for queries. T can be either a constant number, or an average number, of units of text used for determining context for queries during the training of the LLM.

Conventionally, the N units are processed together to determine a context for the query, and if N deviates from T, the response to the query becomes increasingly inaccurate as the magnitude of the difference between N and T increases.

Embodiments of the present invention mitigate the preceding inaccuracy of the response to the query, by distributing embeddings of the N units of text into separate memory portions of the external memory unit and processing each memory portion of embeddings independently and recursively, wherein each memory portion contains embeddings of S units of text, and wherein the memory portion size S is equal to T in one embodiment.

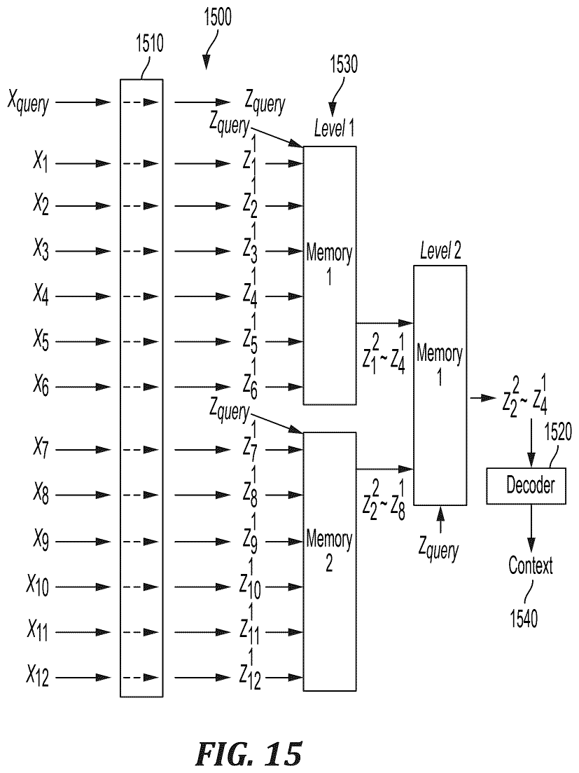

FIG. 15 illustrates an example of determining a context for a query X submitted to a generative LLM 1500, in accordance with embodiments of the present invention.

The generative LLM 1500, which includes an encoder 1510 and a decoder 1520, is augmented by an external memory unit 1530 comprising two memory portions, namely a first memory portion (Memory 1) and a second memory portion (Memory 2).

The query X and 12 units of text (X₁, . . . , X₁₂) are received by the encoder 1510.

An embedding (Z_{query}) of the query X is generated, and 12 embeddings Z₁¹, . . . , Z₁₂¹ of the 12 units of text X₁, . . . , X₁₂ are generated, respectively.

An embedding of text is a vector of real numbers that capture the meaning of the text.

A context for the query X may be determined by finding which embedding of the 12 embeddings Z₁¹, . . . , Z₁₂¹ is closest to the embedding Z_{query} of the query X as follows.

The 12 embeddings are distributed into the two memory portions by storing the first 6 embeddings Z₁¹, . . . , Z₆¹ into Memory 1 and the last 6 embeddings Z₇¹, . . . , Z₁₂¹ into Memory 2.

In a first recursive iteration, the embedding Z₄¹ is determined to be the embedding of the first 6 embeddings that is closest to Z_{query} and is thus denoted as Z₁². Similarly, the embedding Z₈¹ is determined to be the embedding of the last 6 embeddings that is closest to Z_{query} and is thus denoted as Z₂². Then Z₁² and Z₂² are stored in Memory 1.

In a second recursive iteration, the embedding Z₁²=Z₄¹ is determined to be the embedding of the 2 embeddings (Z₁², Z₂²) that is closest to Z_{query} and is thus denoted as Z₂² which is a single closest element to Z_{query}.

Then Z₄¹ is processed by the decoder 1520 to infer the context 1540 from Z₄¹.

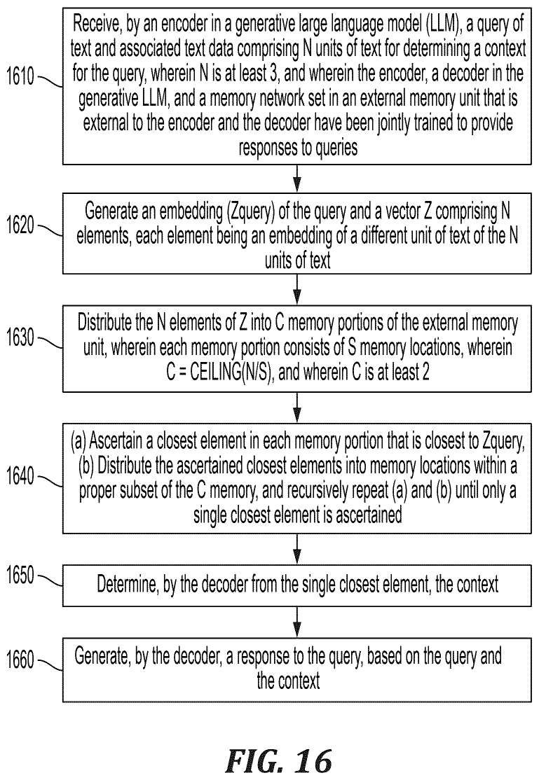

FIG. 16 is a flow chart of a method for generating a response to the query by a generative LLM using memory portions in an external memory unit recursively to determine a context for the query, in accordance with embodiments of the present invention. The flow chart of FIG. 16 includes steps 1610-1660.

Step 1610 receives, by an encoder in the generative LLM, a query of text and associated text data comprising N units of text for determining a context for the query, wherein N is at least 3, and wherein the encoder, a decoder in the generative LLM, and a memory network set in an external memory unit that is external to the encoder and the decoder have been jointly trained to provide responses to queries using context with the queries.

Step 1620 generates an embedding (Z_{query}) of the query and a vector Z comprising N elements, each element being an embedding of a different unit of text of the N units of text.

Step 1630 distributes the N elements of Z into C memory portions of the external memory unit, wherein each memory portion consists of S memory locations, wherein C=CEILING (N/S), and wherein C is at least 2.

The function CEILING (A) is defined as returning a least integer greater than or equal to A, where A is a real number.

The reason for the CEILING function is illustrated in the example of FIG. 15 in which N=12 and S=6) so that C=CEILING (12/6)=2, resulting in the 2 memory portions of MEMORY1 and MEMORY 2.

If N is changed in the example of FIGS. 15 to N=14 with S=6, then there would be a 13^{th} embedding of Z₁₃¹ and CEILING (13/6)=3, resulting in the 3 memory portions of MEMORY1, MEMORY 2, and MEMORY 3 with embeddings Z₁¹, . . . , Z₆¹ stored in Memory 1, embeddings Z₇¹, . . . , Z₁₂¹ stored in Memory 2, and embeddings Z₁₃¹ and Z₁₄¹ stored in Memory 3.

In one embodiment, N mod S=0 which corresponds to CEILING (N/S)=N/S.

In one embodiment, N mod S>0 which corresponds to CEILING (N/S)=N/S+1.

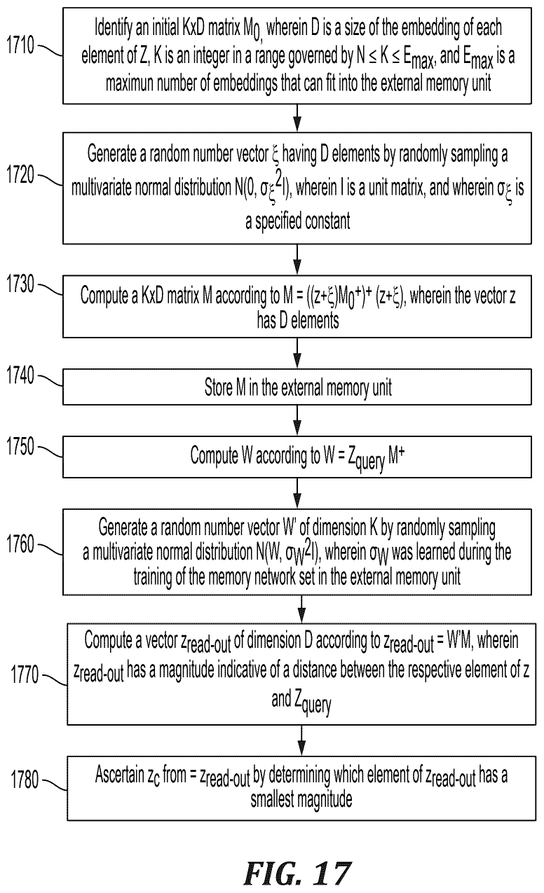

Step 1640: (a) ascertains a closest element in each memory portion that is closest to Z_{query}, (b) distributes the ascertained closest elements into memory locations within a proper subset of the C memory portions, and recursively repeats (a) and (b) until only a single closest element is ascertained. Using memory recursively to determine the context in step 1640 utilizes a memory hierarchy similar to the memory hierarchy found in the hippocampus and improves an accuracy of the response to the query. FIG. 17 describes an embodiment for implementing (a).

A proper subset of a set A is defined to be a subset B of A that satisfies the following conditions: (i) every element of B is also an element of A; and (ii) B is not equal to A.

Step 1650 determines, by the decoder from the single closest element, the context.

Step 1660 generates, by the decoder, a response to the query based on the query and the context.

Regarding (a) in step 1640, let z denote a vector of dimension S that is a subset of the vector Z and is stored in a memory portion P of the C memory portions or of one of the proper subsets of the C memory portions. Ascertaining the closest element (z_{c}) in the memory portion P that is closest to Z_{query} is described in FIG. 17.

In one embodiment, the memory network set in the external memory unit was trained with memory portions consisting of T memory locations or an average of T memory locations, wherein 2≤T≤S.

In one embodiment, S=T.

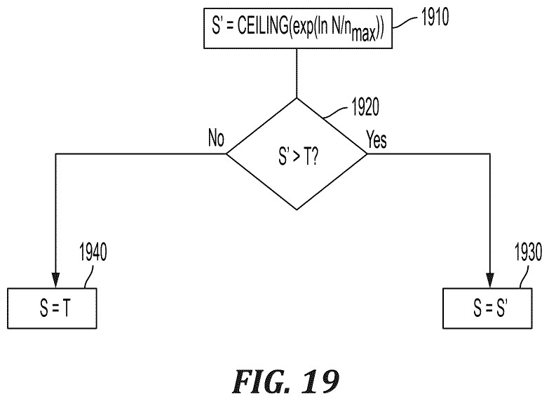

In one embodiment, S is determined by a process described in FIG. 19.

FIG. 17 is a flow chart of a process that ascertains the closest element (z_{c}) in the memory portion P that is closest to Z_{query}, in accordance with embodiments of the present invention. The flow chart of FIG. 17 includes steps 1710-1780.

Steps 1710-1740 describe computing and storing, in the external memory unit, a matrix M that includes information about the embeddings stored in the memory portion P. Steps 1750-1780 process the matrix M to ascertain the closest element z_{c}.

Step 1710 identifies an initial K×D matrix M₀. In one embodiment, M₀ is a unit matrix. D is a size of the embedding of each element of Z, K is an integer in a range governed by N≤K≤Eₘₐₓ, and Eₘₐₓ is a maximum number of embeddings that can fit into the external memory unit.

Step 1720 generates generating a random number vector § having D elements by randomly sampling a multivariate normal distribution N(0, σ_{ξ}²I), wherein I is a unit matrix, and wherein σ_{ξ} is a specified constant.

Step 1730 computes a K×D matrix M according to M=((z+ξ)M₀⁺)⁺ (z+ξ), wherein the vector z has D elements. The ⁺ operator denotes a pseudoinverse operation, wherein z is a vector that is a subset of the vector Z and is stored in the memory portion P of the C memory portions or of one of the proper subsets of the C memory portions.

Step 1740 stores M in the external memory unit.

Step 1750 computes W according to W=Z_{query} M⁺.

Step 1760 generates a random number vector W′ of dimension K by randomly sampling a multivariate normal distribution N(W, σ_{w}²I), wherein σ_{w} was learned during the training of the memory network set in the external memory unit. In one embodiment, ow has the value that minimizes the sum of the reconstruction loss and the KL divergence loss during training.

Step 1770 computes a vector Z_{read-out} of dimension D according to Z_{read-out}=W′M, wherein Z_{read-out} has a magnitude indicative of a distance between the respective element of z and Z_{query}.

Step 1780 ascertains z_{c} from Z_{read-out} by determining which element of Z_{read-out} has a smallest magnitude.

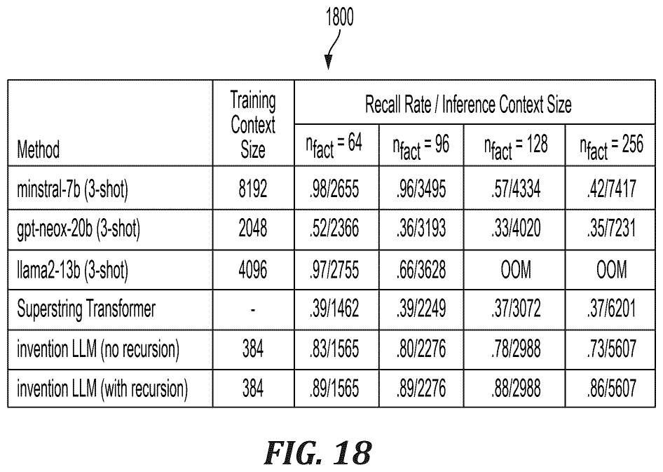

FIG. 18 is a table 1800 depicting FastFacts recall rate performance for baseline AI models and the inventive regenerative LLM models of the present invention, in accordance with embodiments of the present invention. FastFacts is a tool designed to provide quick answers to specific queries.

The baseline AI models are minstral-7b (3-shot), gpt-neox-20b (3-shot), llama2-13b (3-shot), and Superstring Transformer. The inventive regenerative LLM models of the present invention are (i) with no recursion (i.e., S=N) and (ii) with recursion (i.e., S<N)

The FastFacts recall rate is a ratio of the rate of facts retrieved correctly to the total number of facts (n_{fact}) that should have been retrieved.

The training context size is the average size of each fact in bytes used during training.

The inference context size is the average size of each fact in bytes used during inference.

OOM denotes out of memory.

The table 1800 shows that, unlike the baseline models, the inventive regenerative LLM models of the present invention have good recall rate performance at lower and higher context length during inference and can extrapolate from lower context length during training to higher context length during inference (e.g., 384 extrapolated to 1565 for n_{fact}=64).

The table 1800 also shows that, although the baseline models show good recall on small context length, the baseline models recall rates degrade significantly for higher context length.

The table 1800 also shows that the inventive regenerative LLM models of the present invention show higher recall rates with recursion than without recursion.

The recursive memory usage of embodiments of the present invention benefits by attempting to match S to T to compensate for N being typically significantly greater than T, which improves the accuracy of the responses to the queries.

However, matching S to T, instead of having S=N, may increase the computation time due to having to execute multiple recursive iterations (i.e., n recursive iterations wherein n>1). Thus, in one embodiment, S is permitted to deviate from T to reduce the number of recursive iterations.

In this one embodiment, n denotes the total number of recursive iterations, and N, S and n are related approximately via Equation (1).

$${S}^{n} = N \qquad ( 1 )$$

Noting that N is constant, n can be inferred from S via Equation 2 and S can be inferred from n via Equation 3, wherein the CEILING function ensures that n and S are correctly computed as an integer.

$$n = CEILING ( ln N / ln S ) \qquad ( 2 )$$

$$S = CEILING ( exp ( ln N / n ) ) \qquad ( 3 )$$

In this one embodiment, an upper limit imposed on n, denoted as nₘₐₓ, can be substitute for n in Equation (3) which results in Equation (4).

$$S = CEILING ( exp ( ln N / {n}_{max} ) ) \qquad ( 4 )$$

For example, assume N=95000 and T=3. If S is matched to T (i.e., S=3), then n is computed via Equation (2) as n=11.

If, however, n is capped at 9 (i.e., nₘₐₓ=9), then S=4 is inferred from Equation (4).

Thus, in this example, S deviates from T by 1 with a consequent loss of accuracy and a consequent increase in efficiency (i.e., reduction in computation time).

Generally, the memory portion size(S) at the inference is a trade-off between how close S is to the original training size T (to improve performance) and how many embeddings can be fitted in each memory portion (to reduce depth of recursion).

FIG. 19 is a flow chart of a process for determining the number of embeddings(S) to be stored in a memory portion, in accordance with embodiments of the present invention.

The flow chart of FIG. 19 includes steps 1910-1940.

Step 1910 computes S′ according to S′=CEILING (exp (ln N/nₘₐₓ)).

Step 1920 determines whether S′>T. If so (Yes branch from step 1920) then step 1930 is next executed. If not (No branch from step 1920) then step 1940 is next executed.

Step 1930 sets S=S′.

Step 1940 sets S=T.

The memory portion size(S) may also be determined specific to a practical application, such as, inter alia, a topic-based application, a multi-lingual application, a user-based application, and a mixture of experts (MoE) application.

For a topic-based application, there are multiple topics to choose a context from. For example, policy documents within an organization may include multiple topics such as vacations, pension, etc. The recursive memory can be used to answer questions from these topics independently for improved performance. The memory portion size would be a function of the size of documents in each such topic. It is also possible to have further memory units in each such topic if the amount of context in each topic is large.

For a multi-lingual application, available documents have multiple languages. In such a case, multiple memory units can be formed for each language and each memory unit can have further sub-divisions for long context.

For a topic-based application, there are conversations or details about various users in a document corpus, and multiple memories can be used to represent each such user. In this case, the memory portion size for each memory depends on the number of contexts there are for each user.

For a mixture of experts (MoE) application, multiple memory models are trained, with each memory model being a specialist in a certain domain. In this case, the memory portion size of each memory portion would be determined by the training size of each individual memory model.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, said method comprising:
receiving, by an encoder in a generative large language model (LLM), a query of text and associated text data comprising N units of text for determining a context for the query, wherein N is at least 3, and wherein the encoder, a decoder in the generative LLM, and a memory network set in an external memory unit that is external to the encoder and the decoder have been jointly trained to provide responses to queries;
generating, by one or more processors, an embedding (Z_{query}) of the query and a vector Z comprising N elements, each element being an embedding of a different unit of text of the N units of text;
distributing, by the one or more processors, the N elements of Z into C memory portions of the external memory unit, wherein each memory portion consists of S memory locations, wherein C=CEILING (N/S), and wherein C is at least 2;
(a) ascertaining, by the one or more processors, a closest element in each memory portion that is closest to Z_{query}, (b) distributing, by the one or more processors, the ascertained closest elements into memory locations within a proper subset of the C memory portions, and recursively repeating (a) and (b) until only a single closest element is ascertained;
determining, by the decoder from the single closest element, the context; and
generating, by the decoder, a response to the query, based on the query and the context.

2. The method of claim 1, wherein z denotes a vector that is a subset of the vector Z and is stored in a memory portion P of the C memory portions or of one of the proper subsets of the C memory portions, and wherein said ascertaining the closest element z_{c} in the memory portion P that is closest to Z_{query} comprises:
identifying an initial K×D matrix M₀, wherein D is a size of the embedding of each element of Z, K is an integer in a range governed by N≤K≤Eₘₐₓ, and Eₘₐₓ is a maximum number of embeddings that can fit into the external memory unit;
generating a random number vector ξ having D elements by randomly sampling a multivariate normal distribution N(0, σ_{ξ}²I), wherein I is a unit matrix, and wherein σ_{ξ} is a specified constant;
computing a K×D matrix M according to M=((z+ξ)M₀⁺)⁺ (z+ξ), wherein the vector z has D elements; and
storing M in the external memory unit.

3. The method of claim 2, wherein Z_{query} is structured as a vector of dimension D, and wherein said ascertaining the closest element z_{c} in the memory portion P that is closest to Z_{query} further comprises:
computing W according to W=Z_{query} M⁺;
generating a random number vector W′ of dimension K by randomly sampling a has a magnitude indicative of a distance between the respective element of z and Z_{query}; and
ascertaining z_{c} from Z_{read-out} by determining which element of Z_{read-out} has a smallest magnitude.

4. The method of claim 1, wherein the memory network set in the external memory unit was trained with memory portions consisting of T memory locations or an average of T memory locations, wherein 2 #T #S.

5. The method of claim 4, wherein S=T.

6. The method of claim 4, wherein each execution of (a) and (b) is a recursive iteration, wherein n recursive iterations are performed to ascertain the single closest element, wherein nₘₐₓ is a specified maximum value of n, and wherein the method comprises:
computing S′ according to S′=CEILING (exp (ln N/nₘₐₓ));
determining that S′>T; and
setting S=S′.

7. The method of claim 1, wherein N mod S=0.

8. The method of claim 1, wherein N mod S>0.

9. A computer program product, comprising one or more computer readable storage media storing computer readable program instructions, said program instructions executable by one or more processors of a computer system to cause the computer system to perform operations, said operations comprising:
receiving, by an encoder in a generative large language model (LLM), a query of text and associated text data comprising N units of text for determining a context for the query, wherein N is at least 3, and wherein the encoder, a decoder in the generative LLM, and a memory network set in an external memory unit that is external to the encoder and the decoder have been jointly trained to provide responses to queries;
generating, by the one or more processors, an embedding (Z_{query}) of the query and a vector Z comprising N elements, each element being an embedding of a different unit of text of the N units of text;
distributing, by the one or more processors, the N elements of Z into C memory portions of the external memory unit, wherein each memory portion consists of S memory locations, wherein C=CEILING (N/S), and wherein C is at least 2;
(a) ascertaining, by the one or more processors, a closest element in each memory portion that is closest to Z_{query}, (b) distributing, by the one or more processors, the ascertained closest elements into memory locations within a proper subset of the C memory portions, and recursively repeating (a) and (b) until only a single closest element is ascertained;
determining, by the decoder from the single closest element, the context; and
generating, by the decoder, a response to the query, based on the query and the context.

10. The computer program product of claim 9, wherein z denotes a vector that is a subset of the vector Z and is stored in a memory portion P of the C memory portions or of one of the proper subsets of the C memory portions, and wherein said ascertaining the closest element z_{c} in the memory portion P that is closest to Z_{query} comprises:
identifying an initial K×D matrix M₀, wherein D is a size of the embedding of each element of Z, K is an integer in a range governed by N≤K≤Eₘₐₓ, and Eₘₐₓ is a maximum number of embeddings that can fit into the external memory unit;
generating a random number vector ξ having D elements by randomly sampling a multivariate normal distribution N(0, σ_{ξ}²I), wherein I is a unit matrix, and wherein σ_{ξ} is a specified constant;
computing a K×D matrix M according to M=((z+ξ)M₀⁺)⁺ (z+ξ), wherein the vector z has D elements; and
storing M in the external memory unit.

11. The computer program product of claim 10, wherein Z_{query} is structured as a vector of dimension D, and wherein said ascertaining the closest element z_{c} in the memory portion P that is closest to Z_{query} further comprises:
computing W according to W=Z_{query} M⁺;
generating a random number vector W′ of dimension K by randomly sampling a multivariate normal distribution N(W, σ_{W}²I), wherein σ_{W} was learned during the training of the memory network set in the external memory unit;
computing a vector z_{read-out} of dimension D according to z_{read-out}=W′M, wherein z_{read-out} has a magnitude indicative of a distance between the respective element of z and Z_{query}; and ascertaining z_{c} from Z_{read-out} by determining which element of Z_{read-out} has a smallest magnitude.

12. The computer program product of claim 9, wherein the memory network set in the external memory unit was trained with memory portions consisting of T memory locations or an average of T memory locations, wherein 2 #T #S.

13. The computer program product of claim 12, wherein S=T.

14. The computer program product of claim 12, wherein each execution of (a) and (b) is a recursive iteration, wherein n recursive iterations are performed to ascertain the single closest element, wherein nₘₐₓ is a specified maximum value of n, and wherein the method comprises:
computing S′ according to S′=CEILING (exp (ln N/nₘₐₓ));
determining that S′>T; and
setting S=S′.

15. A computer system, comprising one or more processors, one or more memories, and one or more computer readable storage media, and computer readable program instructions executable by the one or more processors via the one or more memories to cause the computer system to perform operations, said operations comprising:
receiving, by an encoder in a generative large language model (LLM), a query of text and associated text data comprising N units of text for determining a context for the query, wherein N is at least 3, and wherein the encoder, a decoder in the generative LLM, and a memory network set in an external memory unit that is external to the encoder and the decoder have been jointly trained to provide responses to queries;
generating, by the one or more processors, an embedding (Z_{query}) of the query and a vector Z comprising N elements, each element being an embedding of a different unit of text of the N units of text;
distributing, by the one or more processors, the N elements of Z into C memory portions of the external memory unit, wherein each memory portion consists of S memory locations, wherein C=CEILING (N/S), and wherein C is at least 2;
(a) ascertaining, by the one or more processors, a closest element in each memory portion that is closest to Z_{query}, (b) distributing, by the one or more processors, the ascertained closest elements into memory locations within a proper subset of the C memory portions, and recursively repeating (a) and (b) until only a single closest element is ascertained;
determining, by the decoder from the single closest element, the context; and
generating, by the decoder, a response to the query, based on the query and the context.

16. The computer system of claim 15, wherein z denotes a vector that is a subset of the vector Z and is stored in a memory portion P of the C memory portions or of one of the proper subsets of the C memory portions, and wherein said ascertaining the closest element z_{c} in the memory portion P that is closest to Z_{query} comprises:
identifying an initial K×D matrix M₀, wherein D is a size of the embedding of each element of Z, K is an integer in a range governed by N≤K≤Eₘₐₓ, and Eₘₐₓ is a maximum number of embeddings that can fit into the external memory unit;
generating a random number vector ξ having D elements by randomly sampling a multivariate normal distribution N(0, σ_{ξ}²I), wherein I is a unit matrix, and wherein σ_{ξ} is a specified constant;
computing a K×D matrix M according to M=((z+ξ)M₀⁺)⁺ (z+ξ), wherein the vector z has D elements; and
storing M in the external memory unit.

17. The computer system of claim 16, wherein Z_{query} is structured as a vector of dimension D, and wherein said ascertaining the closest element z_{c} in the memory portion P that is closest to Z_{query} further comprises:
computing W according to W=Z_{query} M⁺;
generating a random number vector W′ of dimension K by randomly sampling a multivariate normal distribution N(W, σ_{W}²I), wherein σ_{W} was learned during the training of the memory network set in the external memory unit;
computing a vector z_{read-out} of dimension D according to z_{read-out}=W′M, wherein z_{read-out} has a magnitude indicative of a distance between the respective element of z and Z_{query}; and ascertaining z_{c} from Z_{read-out} by determining which element of Z_{read-out} has a smallest magnitude.

18. The computer system of claim 15, wherein the memory network set in the external memory unit was trained with memory portions consisting of T memory locations or an average of T memory locations, wherein 2 #T #S.

19. The computer system of claim 18, wherein S=T.

20. The computer system of claim 18, wherein each execution of (a) and (b) is a recursive iteration, wherein n recursive iterations are performed to ascertain the single closest element, wherein nₘₐₓ is a specified maximum value of n, and wherein the method comprises:
computing S′ according to S′=CEILING (exp (ln N/nₘₐₓ));
determining that S′>T; and
setting S=S′.
